(19) United States
(12) Patent Application Publication
(10) Pub. No.: US 2004/0003225 A1
(43) Pub. Date: Jan. 1, 2004

(54) METHOD OF READING DATA STORED IN AN OPTICAL MEDIUM OF A COMPUTER SYSTEM

(76) Inventors: Yu-Chih Cheng, Taipei Hsien (TW); Ming-Horn Tsai, Taipei Hsien (TW); Xin Zhang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,150

(22) Filed: Mar. 19, 2003

(30) Foreign Application Priority Data
Jun. 28, 2002 (TW) 091114317

(51) Int. Cl. G06F 9/00

(52) U.S. Cl. 713/1

(57) ABSTRACT

A method for reading data stored in an optical disc of a computer system. The method enables the computer system to execute a media-player program while the computer is performing a power-on-self-test (POST) stored in a basic input/output system (BIOS), and play the optical disc with low power consumption. The media-player program is executed upon reception of an interrupt signal during the POST.

### BACKGROUND OF INVENTION

1. Field of the Invention

The present invention relates to methods of reading data stored on an optical medium of a computer system, and more particularly, the present invention provides a method of entering a media-player program in the computer system while the computer system is performing a power-on-self-test stored in a basic input/output system (BIOS), and playing information stored on the optical medium while the computer system is in a low-power mode.

2. Description of the Prior Art

In the past twenty years, computer technology has advanced to a point where personal computers provide high-power calculation, and other derivative features. Current computers are almost all equipped with GFLOPS-class (GFLOPS: billion floating point operations per second) processors, a 3D display card capable of processing millions of 3D polygon calculations per second, and a sound card that can support a 3D sound environment. In the past, such features were only available on workstation-class computers, but now these features are yesterday's news in the PC world.

However, in contrast with the elaborate features mentioned above, sometimes a user wishes only to perform a simple task, such as playing a music optical disc. Because controller chips of optical disc drives are already capable of reading encoded sound tracks, for all intents and purposes, the CPU need not lift a proverbial finger. This tells us that we only need a simple program for playing optical discs and a minority of components of the PC to be able to play music optical discs.

However, to play a music optical disc on a PC, the user currently must endure the following steps:

(a) Turning on the PC;

(b) Waiting for the BIOS to perform each of a number of self-tests;

(c) The PC searching for a magnetic storage device, and then loading an operating system from the device;

(d) Loading a driver program for the optical disc drive in the operating system; and

(e) Executing a media-player program in the operating system.

We can see that in the prior art technology, before a user can use the internal optical disc drive of the PC to play the music optical disc, the user must complete the above steps. In addition, the prior art exhibits the following deficiencies:

(1) Because the CPU of the PC is heavily loaded, a considerable amount of power is consumed by the CPU;

(2) The power consumption of the CPU produces a lot of wasted heat, and the CPU must dissipate the heat with a fan and a heat sink. The fans produce a lot of high-frequency noise, significantly lowering the quality of the listening experience;

(3) At least one magnetic storage device is needed to store the media-player program, and the storage device also makes a lot of noise when spinning; and

(4) Because the operating system is very large, and complicated, it requires a long loading time, which is inconvenient for the user who only wants to use the computer to listen to the music optical disc on the internal PC optical disc drive.

### SUMMARY OF INVENTION

Therefore, it is an objective of the claimed invention to provide a method of using a computer system to read information from an optical medium, the computer capable of entering a media-player program during a power-on-self-test (POST) of a basic input/output system (BIOS) of the PC.

Briefly, a computer system of the claimed invention has a basic input/output system (BIOS), which executes power-on procedures of the computer system, and has a media-player program. While the BIOS is executing the power-on procedures of the computer system, the BIOS is capable of interrupting the power-on procedures. The BIOS then executes the media-player program, allowing the BIOS to read information stored on an optical medium without having finished the power-on procedures of the computer system.

It is an advantage of the method of the claimed invention that it saves time and power when playing an optical medium on a PC, as well as reducing environmental noise that inhibits a listening experience of a user.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a computer system according to the present invention.

FIG. 2 is a flow chart of a power-on process of the computer system of FIG. 1.

FIG. 3 is a perspective view of a user interface of the present invention.

### DETAILED DESCRIPTION

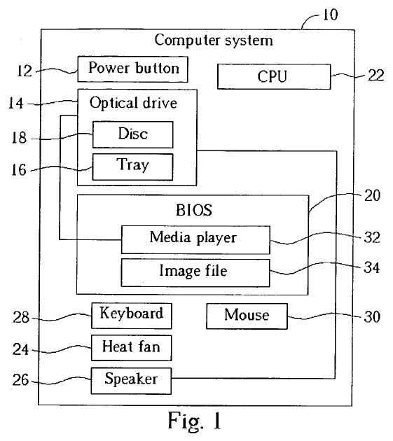

Please refer to FIG. 1, which is a block diagram of a computer system 10, according to the present invention. The computer 10 comprises a power button 12 for turning on the computer 10, an optical disc drive 14 for playing a optical disc 18 placed on a tray 16 of the optical disc drive 14, a BIOS 20 for executing a power-on procedure of the computer system 10, a CPU 22, a heat-dissipating fan 24 for lowering a temperature of the CPU 22, a speaker 26 connected to the optical disc drive 14, and a keyboard 28 and a mouse 30 for entering control signals. The BIOS 20 internally stores a media-player program 32 and an image file 34. In this embodiment, the optical disc drive 14 uses an Advanced Technology Attachment Packet Interface (ATAPI), defined by the Small Form Factor (SFF) Committee.

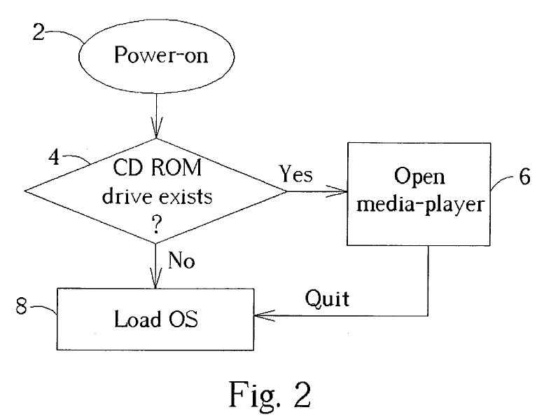

Please refer to FIG. 2, which is a flow chart of power-on procedures of the computer system 10. As shown, the computer system 10 powers on according to the following flow of events: Step 2: A user presses the power button 12 to turn on the computer 10; go to step 4;

Step 4: Execute an internal power-on-self-test (POST) of the BIOS to check sequentially the CPU 22, a main RAM, a hard disk, and the optical disc drive 14; if the optical disc drive 14 is found, go to step 6, else, go to step 8;

Step 6: The BIOS 20 decides whether or not to execute the media-player program 32 based on: the user inputting a control signal from the keyboard 28 or the mouse 30, the playable optical disc 18 being in the optical disc drive 14, or three default modes of the BIOS 20; if, after the user has entered the media-player program 32, the user decides to quit, go to step 8;

Step 8: The BIOS 20 finds a suitable magnetic drive to start the computer 10, and loads an operating system of the computer.

The three default modes of step 6 for entering the media-player program 32 are:

(1) Keystroke Decision Mode: After turning on the computer, while the BIOS 20 performs the POST, a reminder is displayed on a monitor, such as “Would you like to enter the media-player?” If the user presses a button representing “yes,” the media-player program 32 is executed immediately; if the user does not press the button representing “yes” within a limited period of time, the BIOS 20 continues on to execute the operating system;

(2) Self-test Mode: During the power-on test, the BIOS 20 conducts a check to determine whether or not the playable optical disc 18 is in the optical disc player 14. If so, the BIOS 20 automatically enters the media-player program 32; if not, the BIOS 20 continues to load the operating system;

(3) Automatic Mode: After turning on the computer 10, the BIOS 20 unconditionally executes the media-player program 32 after performing preliminary self-tests;

Regardless of under which mode the media-player program 32 is executed, the user can always quit the program 32 and continue loading the operating system.

After the user decides to execute the media-player program 32 by any of the above-mentioned methods, by order of the BIOS 20, the computer system 10 loads the media-player program 32 from a specific location in the BIOS 20, and also loads the image file 34. The media-player program 32 comprises the following program code:

(1) Code to control the optical disc drive 14 of the computer system 10;

(2) Code to shut down the computer system 10, or to continue loading the operating system; and

(3) Code to handle processing exceptions.

The image file 34 is a GIF file, covering a user interface, and can be changed to suit the user's preference.

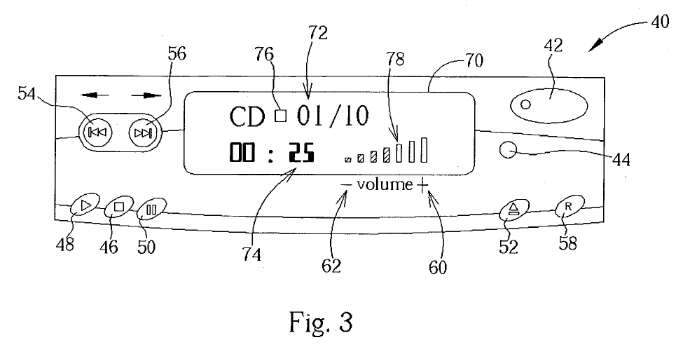

Please refer to FIG. 3, which is a perspective view of the user interface 40. When the user executes the media-player program 32, the user sees the user interface 40 shown in FIG. 3. The user interface 40 comprises a Power-Off button 42, a Boot-to-OS button 44, a Stop button 46, a Play button 48, a Pause button 50, an Eject button 52, a Next button 54, a Back button 56, a Repeat button 58, a Volume Up button 60, and a Volume Down button 62. Each function button corresponds to a different key of the keyboard 28 of the computer system 10. The following is a description of important and special-function buttons:

Power-Off button 42: Allows the user to shutdown the computer system 10 directly while in the media-player program 32;

Boot-to-OS button 44: Allows the user, from within the media-player program 32, to cause the computer 10 to finish the previously interrupted power-on procedures and go on to load the operating system; and

Repeat button 58: Allows the user to repeat one song, or an entire album.

Please refer again to the user interface 40, which further comprises an optical disc information display interface 70 for allowing the user to acquaint himself with essential information about the optical disc 18. The optical disc information display interface 70 comprises:

A track order 72: Tells the user which track is currently being played;

A seconds count 74: Tells the user how many seconds have been played, or remain, of the current track (can be decided by the user);

A playing mode 76: Tells the user what the current playing mode is (single repeat, album repeat, or no repeat); and

A volume level 78: Tells the user the current volume level (seven levels are displayable in FIG. 3).

The media-player program 32 handles any exceptional cases that may occur when the user is operating the media-player program 32, preventing the media-player program 32 from inadvertently entering an infinite loop and crashing the computer 10.

After entering the media-player program 32, because the CPU 22 has virtually no processing load, the BIOS 20 can put the CPU 22 in a complete idle state, minimizing the power consumed by the CPU 22. Also, because the power consumption decreases, the rotation speed of the heat fan 24 covering the CPU 22 can be dropped by more than one half its original, which not only saves power, but also eliminates high frequency noise and improves the listening experience.

In addition, the user can enter the media-player program 32 internal to the BIOS 20 in less than 10 seconds after turning on the computer 10. The present invention provides the user with complete information about the optical disc, an attractive interface, and big power savings.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of reading information from an optical disc in a computer system, the computer system comprising a basic input/output system (BIOS) for executing power-on procedures of the computer system, and a media-player program stored in the computer system, the method comprising:
while the BIOS is executing the power-on procedures of the computer system, the BIOS interrupting the power-on procedures and executing the media-player program, and playing the information stored on the optical disc without having completed the power-on procedures of the computer system.

2. The method of claim 1 further comprising:
displaying an image file on a display of the computer system as a user interface.

3. The method of claim 2 further comprising:
depressing a Boot-to-OS button in the user interface for causing the BIOS to finish the power-on procedures of the computer system.

4. The method of claim 2 further comprising:
depressing a Power-off button in the user interface for causing the BIOS to shutdown the computer system.

5. The method of claim 2 further comprising:
depressing an Eject button in the user interface for causing the BIOS to open a tray of an optical disc drive that is playing the optical disc.

6. The method of claim 2 further comprising:
depressing a Pause key in the user interface for causing the BIOS to pause play of the optical disc.

7. The method of claim 2 further comprising:
depressing a Repeat key in the user interface for causing the BIOS to repeatedly play a part of the information stored on the optical disc, or all of the information stored on the optical disc.

8. The method of claim 2 further comprising:
the user interface displaying information about a volume, a track number, a time passed, and a time remaining.

9. The method of claim 1 further comprising:
while executing the media-player program, causing a CPU of the computer system to enter a low-power mode for reducing an overall power consumed by the computer system.

10. The method of claim 9 further comprising:
while the CPU is in the low-power mode, reducing a rotation speed of a heat fan of the computer system to lower an overall noise produced by the computer system.

11. The method of claim 1 further comprising:
configuring the computer system in such a way that the BIOS interrupts the power-on procedures when the BIOS detects the optical disc while executing the power-on procedures.

12. The method of claim 1 further comprising:
configuring the computer system in such a way that the BIOS interrupts the power-on procedures without any user action when the BIOS is executing the power-on procedures of the computer system.

13. The method of claim 1 further comprising:
configuring the computer system in such a way that the BIOS interrupts the power-on procedures according to a user key-stroke when the BIOS is executing the power-on procedures of the computer system.

14. A computer system comprising:
a basic input/output system (BIOS) for executing power-on procedures of the computer system;
a media-playing program stored in the computer system; and
an optical disc player for playing an optical disc;
wherein while the BIOS is executing the power-on procedures of the computer system, the BIOS is capable of interrupting the power-on procedures, and executing the media-player program, allowing the BIOS to play the information stored on the optical disc while not having completed the power-on procedures of the computer system.

15. The computer system of claim 14 wherein the media-player program is stored in the BIOS.

16. The computer system of claim 14 further comprising a display for displaying information, and the BIOS further comprising an image file, wherein when the image file is opened, the display shows a user interface.

17. The computer system of claim 16 wherein the image file is capable of being changed.

18. The computer system of claim 16 wherein the user interface comprises a Boot-to-OS button for causing the BIOS to finish the interrupted power-on procedures.

19. The computer system of claim 16 wherein the user interface comprises a Power-off button for causing the BIOS to shutdown the computer system.

20. The computer system of claim 16 wherein the user interface comprises an Eject button for causing the BIOS to open a tray of the optical disc player.

21. The computer system of claim 16 wherein the user interface comprises a Pause button for causing the BIOS to pause play of the optical disc.

22. The computer system of claim 16 wherein the user interface comprises a Repeat button for causing the BIOS to repeatedly play a part of the information stored on the optical disc, or all of the information stored on the optical disc.

23. The computer system of claim 16 wherein the user interface comprises information about a volume, a track number, a time expired, and a time remaining.

24. The computer system of claim 14 further comprising a central processing unit (CPU), wherein while the media-player program is being executed, the CPU enters a low-power mode, lowering an overall power consumption of the computer system.

25. The computer system of claim 24 further comprising a heat fan, wherein when the CPU enters the low-power mode, a rotation speed of the heat fan is lowered for reducing overall noise produced by the computer system.

26. The computer system of claim 14 further comprising a speaker, or a plurality of speakers, for playing audio signals stored in the optical disc.

27. The computer system of claim 14 further comprising an input device for inputting interrupt signals to make the BIOS interrupt the power-on procedures of the computer system.

28. The computer system of claim 27 wherein the input device is a keyboard or a mouse.

29. The computer system of claim 14 wherein when the BIOS, during executing the power-on procedures, detects a optical disc, the BIOS interrupts the power-on procedures.

30. The computer system of claim 14 wherein when the BIOS is executing the power-on procedures, the BIOS interrupts the power-on procedures.

31. The computer system of claim 14 wherein the media-player program further comprises exception handling procedures for handling exceptions that are produced during execution of the media-player program.

32. The computer system of claim 31 wherein the exceptions comprise accidentally pressing an eject button during play of the optical disc.

33. The computer system of claim 14 wherein the media-player program comprises an interface for connecting the media-player program to a bus of the optical disc player.

34. The computer system of claim 33 wherein the interface is an Advanced Technology Attachment Packet Interface (ATAPI).
